(19) United States
(12) Patent Application Publication
(10) Pub. No.: US 2011/0078092 A1
(43) Pub. Date: Mar. 31, 2011

(54) APPARATUS AND METHOD FOR CONTROLLING A BATTERY

(75) Inventors: Hyungsun KIM, Seoul (KR); Youngjun PARK, Gyeonggi-Do (KR); Insung JUNG, Seoul (KR); Jongun LIM, Gyeonggi-Do (KR)

(73) Assignee: LG ELECTRONICS INC., Seoul (KR)

(21) Appl. No.: 12/862,813

(22) Filed: Aug. 25, 2010

(30) Foreign Application Priority Data
Sep. 25, 2009 (KR) 10-2009-0091281
Dec. 1, 2009 (KR) 10-2009-0118076

(51) Int. Cl. H02J 7/00; G06F 17/00

(52) U.S. Cl. 705/412; 320/109; 180/65.29

(57) ABSTRACT

An apparatus and method for controlling a battery are disclosed to charge the battery by a certain device or discharge the voltage charged in the battery to the certain device based on configuration information and status information of the battery. A system for charging of an electric vehicle battery leveraging smart power grid technology, the system comprising: a wireless communication unit configured to establish a wireless communication session with a wireless device and receive control information relating to battery charge management for an electric vehicle battery; a memory configured to store one or more characteristics of an electric vehicle battery charge station; a detection unit configured to identify battery status information for the electric vehicle battery; and a controller configured to generate a control signal based on at least two of the control information, the battery status information, and the characteristics; wherein the control information includes information that can be used to identify a target capacity for the electric vehicle battery.

### CROSS-REFERENCE TO RELATED APPLICATION

Pursuant to 35 U.S.C. §119(a), this application claims the benefit of an earlier filing date and right of priority to Korean Application No. 10-2009-0091281, filed on Sep. 25, 2009 and Korean Application No. 10-2009-0118076, filed on Dec. 1, 2009, the contents of which is incorporated by reference herein in its entirety.

### BACKGROUND OF THE INVENTION

1. Field of the Invention

The present invention relates to an apparatus and method for controlling a battery.

2. Description of the Related Art

In general, a battery controlling apparatus (in particular, a battery controlling apparatus of vehicle) is a device for uniformly maintaining the voltage of battery cells in order to improve stability of the battery cells, lengthen a life span of the battery cells, and obtain a high output of the battery cells.

### SUMMARY OF THE INVENTION

According to an aspect of the present invention, there is provided a process of using a wireless device to facilitate charging of an electric vehicle battery leveraging smart power grid technology, including; establishing a wireless communication session between a wireless device and an electric vehicle battery charge station; identifying one or more characteristics of the electric vehicle battery charge station; obtaining control information from a user of the wireless device relating to battery charge management for an electric vehicle battery; storing the control information to a database; identifying battery status information for the electric vehicle battery; generating a control signal based on at least two of the obtained control information, the identified battery status information, and the identified characteristics; and indicating to the user, by leveraging a user interface of the wireless device, power transfer information; wherein the obtained control information includes information that can be used to identify a target capacity for the electric vehicle battery.

According to another aspect of the present invention, there is provided a system for charging of an electric vehicle battery leveraging smart power grid technology, including: a wireless communication unit configured to establish a wireless communication session with a wireless device and receive control information relating to battery charge management for an electric vehicle battery; a memory configured to store one or more characteristics of an electric vehicle battery charge station; a detection unit configured to identify battery status information for the electric vehicle battery; and a controller configured to generate a control signal based on at least two of the control information, the battery status information, and the characteristics; wherein the control information includes information that can be used to identify a target capacity for the electric vehicle battery.

According to another aspect of the present invention, there is provided a system for charging of an electric vehicle battery leveraging smart power grid technology, including: a wireless communication unit configured to establish a wireless communication session with a wireless device; a memory configured to store one or more characteristics of an electric vehicle battery charge station; means for obtaining control information from a user of the wireless device relating to battery charge management for an electric vehicle battery; a detection unit configured to identify battery status information for the electric vehicle battery; and a controller configured to generate a control signal based on at least two of the control information, the battery status information, and the characteristics; wherein the control information includes information that can be used to identify a target capacity for the electric vehicle battery.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a battery of an electric vehicle according to an exemplary embodiment of the present invention;

FIG. 2 is a schematic block diagram showing the configuration of a hybrid electric vehicle according to an exemplary embodiment of the present invention;

FIG. 3 is a schematic block diagram showing the configuration of an apparatus for controlling a battery according to an exemplary embodiment of the present invention;

FIG. 4 is a flow chart showing the process of a method for controlling a battery according to a first exemplary embodiment of the present invention;

FIG. 5 is a flow chart showing the process of a method for controlling a battery according to a second exemplary embodiment of the present invention;

FIG. 6 is a schematic block diagram showing the configuration of a system for controlling a battery according to an exemplary embodiment of the present invention;

FIG. 7 is a signal flow chart showing a communication process of the system for controlling a battery according to a third exemplary embodiment of the present invention; and

FIG. 8 is a flow chart showing the process of a method for controlling a battery according to a fourth exemplary embodiment of the present invention.

### DETAILED DESCRIPTION OF THE INVENTION

An apparatus and method for controlling a battery according to exemplary embodiments of the present invention will now be described with reference to the accompanying drawings. In the following description, the same reference numerals are used for the same or equivalent elements regardless of reference numerals, and a repeated description thereof will be omitted.

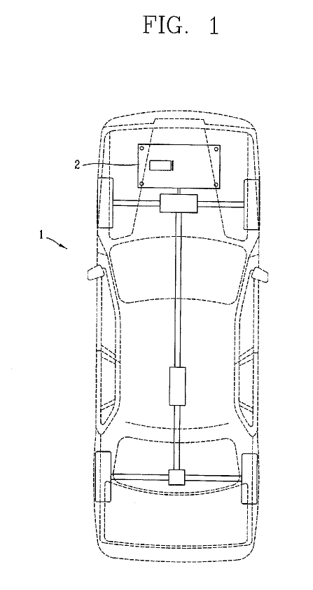

FIG. 1 is a view showing a battery of an electric vehicle according to an exemplary embodiment of the present invention. An apparatus and method for controlling a battery according to an exemplary embodiment of the present invention may be employed for various electric and electronic devices that use a battery, as well as for an internal combustion vehicle (ICV), an electric vehicle (EV), or a hybrid electric vehicle (HEV).

As shown in FIG. 1, the electric vehicle 1 includes a battery 2 for supplying power to a motor. For example, a hybrid vehicle includes a battery pack composed of a plurality of cells in order to be provided with required power. It is desirable for the plurality of battery cells included in the battery pack to have a uniform voltage, respectively, in order to obtain stability, improve life span of the batteries, and obtain a high output from the batteries. The battery controlling apparatus allows for each of the plurality of battery cells to have a proper voltage while charging or discharging the batteries of the battery pack. In some instances, various factors, such as a change in internal impedance or the like, can affect the ability of the plurality of battery cells to maintain a balanced, stable state. In such instances, a battery management system can implement a balancing function in order to balance a state of charge of the plurality of battery cells.

For example, there occurs a difference in a state of charge (SOC) (or a remaining capacity) among the battery cells within the battery pack with the lapse of time due to a difference in the self-discharge rate of the battery cells within the battery pack. Thus, in order to overcome the capacity imbalance among the battery cells, a circuit is configured to increase and/or decrease energy discharge in each battery cell.

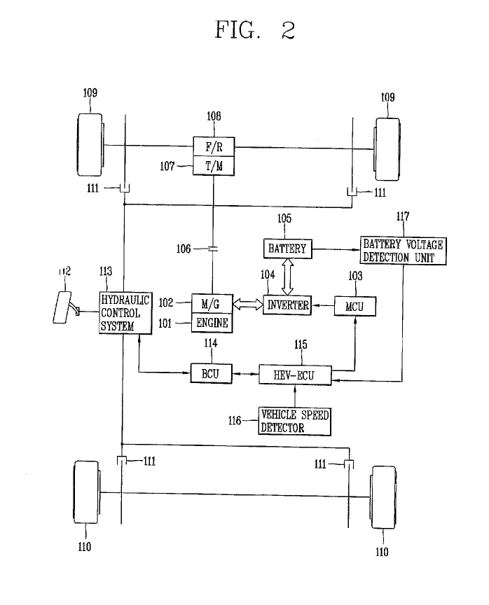

FIG. 2 is a schematic block diagram showing a configuration of a hybrid electric vehicle according to an exemplary embodiment of the present invention. The apparatus and method for controlling a battery according to an exemplary embodiment of the present invention can be applicable for an electric vehicle (EV) and an internal combustion vehicle (ICV) as well as for a hybrid electric vehicle (HEV).

As shown in FIG. 2, the hybrid vehicle includes an engine 101 and a motor/generator unit (M/G unit) 102 as power sources. The wheels driven by the power sources can be front wheels in a front-wheel drive vehicle or rear wheels in a rear wheel drive vehicle. Hereinafter, the front wheel drive vehicle will be described. An embodiment of the rear wheel drive vehicle will be obvious from the following description of the front wheel drive vehicle.

The M/G unit 102 is a device selectively serving as a motor or a generator according to a driving state, which is obvious to the skilled person in the art. Thus, in the following description, for the sake of understanding, the M/G unit 102 may be used as the same title of the motor or the generator but all of them do not designate the same element. The engine 101 and the motor 102 in the electric vehicle are connected in series to a transmission.

Also, the M/G unit 102 is driven by a signal of an inverter 104 under the control of a motor control unit (MCU) 103. The inverter 104 as a power source drives the M/G unit 102 by using electric energy stored in a battery 105 under the control of the MCU 103. When the inverter 104 drives the M/G unit 102 with a generator, it charges electric energy generated in the M/G unit 102 to the battery 105.

Power of the engine 101 and the M/G unit 102 is transferred to a transmission (T/M) 107 through a clutch 106, and transferred to front wheels 109 through a final drive gear (F/R) 108. Rear wheels 110 are non-driven wheels that are not driven by the engine 101 and the M/G unit 102.

A wheel brake apparatus 111 is installed at the front wheels 109 and the rear wheels 110 in order to reduce a rotation speed of the respective wheels. The electric vehicle includes a brake pedal 112 and a hydraulic control system 113 for hydraulically controlling each wheel brake apparatus 111 based on oil pressure generated according to manipulation of the brake pedal 112, in order to drive each wheel brake apparatus 111. The electric vehicle may include a brake control unit (BCU) 114 for receiving a brake control state from the hydraulic control system 113.

When a driver manipulates the brake pedal 112, the BCU 114 detects oil pressure generated from the hydraulic control system 113. The BCU 114 calculates a braking force to be applied to the driven wheels (e.g., the front wheels 109), a hydraulic braking force to be braked by oil pressure, and a regenerative braking force to be braked by regenerative braking based on the detected oil pressure. Accordingly, the BCU 114 supplies the calculated hydraulic braking force to the wheel brake apparatus 111 of the front wheels 109 under the control of the hydraulic control system 113.

The electric vehicle includes a hybrid electric vehicle-electronic control unit (HEV-ECU) 115 communicating with the BCU 114 and the MCU 103 to control them to implement an electric vehicle that performs a maximum speed limiting method.

The regenerative braking force calculated by the BCU 114 is transferred to the HEV-ECU 115, and the HEV-ECU 115 controls the MCU 103 based on the received regenerative braking force. Accordingly, the MCU 103 drives the M/G unit 102 as a generator such that the regenerative braking force designated by the HEV-ECU 115 can be implemented. At this time, electric energy generated by the M/G unit 102 is stored in the battery 105.

The electric vehicle further includes a vehicle speed detector 116 for detecting a vehicle speed. The HEV-ECU 115 utilizes the vehicle speed detected by the vehicle speed detector 116 as data for controlling the BCU 114 and the MCU 103.

The electric vehicle further includes a battery voltage detection unit 117 for detecting the voltage of the battery 105. The battery voltage detection unit 117 detects a current voltage of the battery 105 and provides result data to allow the HEV-ECU 115 to limit a maximum speed of the electric vehicle according to a deviation of the detected current voltage and a pre-set reference voltage.

The electric vehicle drives the motor by using the battery, thus the life span of the battery is a key element of the electric vehicle. The voltage of each of the battery cells of the battery slightly changes over time. Such imbalance is one major factor that can contribute to a reduced life span for the battery. Thus, in order to prevent such imbalance of the battery cells to lengthen the life span of the battery, most electric vehicles must continuously perform cell balancing. The cell balancing is a method of discharging current by connecting a small load to a battery cell having a high voltage, thus allowing the battery cell to have the same voltage as that of other cells.

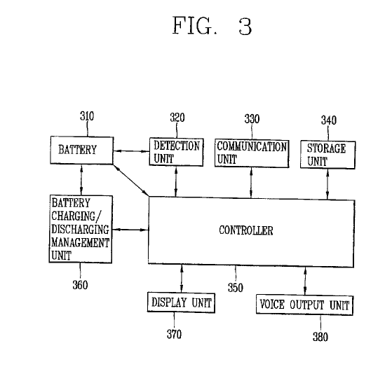

FIG. 3 is a schematic block diagram showing the configuration of an apparatus for controlling a battery according to an exemplary embodiment of the present invention. As shown, the battery controlling apparatus 300 includes a battery 310, a detection unit 320, a communication unit 330, a storage unit 340, a controller 350, a battery charging/discharging management unit 360, a display unit 370, and a voice output unit 380.

The battery 310 may be configured as a single unit, or a plurality of batteries may form a single pack (i.e., a battery pack). When a plurality of batteries is connected in series, one or more safety switches may be installed between the batteries. The detection unit 320 may detect a state of charge (SOC) of the battery 310 in real time. The detection unit 320 may additionally detect the voltage and/or current of each cell of the battery 310 in real time. The detection unit 320 may further measure (or detect) temperature information (including the temperature within the battery 310 and the temperature of the surrounding environment) of the battery 310. The detection unit 320 may additionally detect internal resistance of each cell of the battery 310. Also, the detection unit 320 may calculate a state of health (SOH) of the battery 310 (e.g., whether and/or to what extent the battery has an ability to receive charge) based on the detected voltage value, current value, internal resistance value, temperature information, and the number of times of charging or discharging stored in the storage unit 340.

The communication unit 330 may include one or more elements allowing the battery controlling apparatus 300 and a terminal to perform communication by using a controller area network (CAN), i.e., a vehicle network system, or a short-range communication network. In this case, the terminal may include at least one of certain terminals such as a mobile terminal, a telematics terminal, a smart phone, a portable terminal, a personal digital assistant (PDA), a portable multimedia player (PMP) terminal, a computer, a WiBro terminal, an Internet protocol television (IPTV) terminal, a navigation terminal, an audio video navigation (AVN) terminal, an A/V system, an information providing center, a call center, a server, and the like. In some implementations, the terminal can be provided within a vehicle that includes the battery 310. In some implementations, the terminal can be a wireless device that is separate from the vehicle that includes the battery 310.

The communication unit 330 may transmit status information of the battery 310 transmitted from the battery controlling apparatus 300 to the connected certain terminal in response to a signal requested by the certain terminal.

The communication unit 330 may receive configuration information transmitted in the form of voice data or text data (i.e., short message service (SMS)) from the terminal, and outputs the received configuration information to the storage unit 340 or to the controller 350. In this case, the configuration information may include information regarding charging or discharging such as a charge duration, a charge amount, a charge fee, a discharge duration, a discharge amount, a discharge fee, and the like.

The communication unit 330 can receive discharge configuration information (or selling configuration information) transmitted from the terminal, and can output the received discharge configuration information to the storage unit 340.

The communication unit 330 may include one or more elements allowing the battery controlling apparatus 300 and the terminal included in a wireless communication system to perform radio communication. In some implementations, the communication unit 330 can allow the battery controlling apparatus 300 and a network in which the battery controlling apparatus 300 is positioned to perform radio communication.

The communication unit 330 may include a wireless Internet module or a short-range communication module. Here, the wireless Internet functionality may include a wireless local area network (WLAN), Wi-Fi, wireless broadband (WiBro), world interoperability for microwave access (WiMAX), high speed downlink packet access (HSDPA), a long term evolution (LTE), IEEE 802.16, a wireless mobile broadband service (WMBS), and the like. The short-range communication technique may include Bluetooth™, Radio Frequency IDentification (RFID), Infrared Data Association (IrDA), Ultra-WideBand (UWB), ZigBee™, and the like.

The communication unit 330 may include an interface unit (not shown) serving as an interface with external devices connected with the battery controlling apparatus 300. For example, the interface unit may include wired or wireless headset ports, external power supply ports, wired or wireless data ports, memory card ports, ports for connecting a device having an identification module, audio input/output (I/O) ports, video I/O ports, earphone ports, or the like. The identification module may be a chip that stores various information for authenticating devices attempting to utilize the battery controlling apparatus 300 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the battery controlling apparatus 300 via a port. The interface unit may be used to receive inputs (e.g., data, information, power, etc.) from an external device and transfer the received inputs to one or more elements within the battery controlling apparatus 300 or may be used to transfer data within the battery controlling apparatus 300 to an external device.

When the battery controlling apparatus 300 is connected with an external cradle, the interface unit may serve as a passage to allow power from the cradle to be supplied therethrough to the battery controlling apparatus 300 or may serve as a passage to allow various command signals input by the user from the cradle to be transferred to the battery controlling apparatus 300 therethrough. Various command signals or power inputted from the cradle may operate as signals for recognizing that the battery controlling apparatus 300 is properly mounted on the cradle.

The storage unit 340 may store various user interfaces (UIs) and/or graphic user interfaces (GUIs). The storage unit 340 may also store data, programs, or the like, required for the battery controlling apparatus 300 to operate. The storage unit 340 may additionally store status information of the battery 310. The status information of the battery 310 may include unique information for the battery 310 and units of information (including a state of charge, a voltage value, a current value, temperature information, and the like) detected by the detection unit 320. The unique information of the battery 310 may include a rated capacity, a rated voltage, a rated current, and the like, of a reference battery.

The storage unit 340 may store configuration information received through the communication unit 330 after being transmitted from the external terminal. The storage unit 340 may store discharge configuration information received through the communication unit 330 after being transmitted from the external terminal. The storage unit 340 may store data (including various units of information, control signals, and the like) transmitted from an information providing center (or a call center) or an external terminal connected through wireline/wireless communication.

The storage unit 340 may store battery management information generated by the controller 350. In this case, the battery management information may include charge information, selling information, selling configuration information, running information, battery status information, gas mileage information, status information regarding a vehicle, and the like.

The controller 350 may execute a general controlling function of the battery controlling apparatus 300. The controller 350 may generate a control signal (including, e.g., charge control information, charge stop information, power selling control information, etc.) based on the status information of the battery 310 and the configuration information received through the communication unit 330 and/or the information (including state of charge, a state of health (SOH), a voltage value, a current value, temperature information, and the like) detected by the detection unit 320. The controller 350 can output the generated control signal to the battery charging/discharging management unit 360.

For example, the controller 350 can generate a control signal indicating that the battery 310 is to be charged for a duration of two hours. As another example, the controller 35 can generate a control signal indicating that $30 worth of power is to be discharged (sold) from the battery 310. In some implementations, the status information is also used in generating the control signal. For example, the controller 350 can generate the control signal in response to determining that the battery 310 is capable of receiving a charge. As another example, the controller 350 can use a present charge level of the battery 310 and a desired charge level indicated by the control information to identify a charge duration and generate a control signal that identifies the charge duration. As another example, the controller 350 can compare a present charge level of the battery to a desired charge level indicated by the control information. If the present charge level is equal to the desired charge level, the controller 350 can generate a control signal indicating that charging/discharging of the battery 310 should be halted.

In some implementations, the controller 350 can generate control signals based on a cost of power. For example, control information provided by the user (e.g., via the terminal) can be include an indication of a price at which power is to be charged/discharged with respect to the battery 310. For example, the control information can indicate that a charging function for the battery 310 is to be initiated when the cost of power reaches a specified price per KW. The controller 350 can generate a control signal to start charging of the battery 310 when the cost of power is at or below the indicated price. As another example, the control information can indicate that power is to be sold from the battery 310 when the cost of power is at or above an indicated price, until the charge level of the battery reaches a specified level.

In some implementations, peak, average, and minimum costs for power over a given time period can be calculated. For example, the cost of power can be recorded at regular intervals over a three day period. This information can then be used to identify peak, average, and minimum power costs for the three day period. The control information can indicate that power is to be transferred based on the peak, average, and/or minimum cost values. For example, the control information can indicate that power is to be sold whenever the cost is at or above the average cost for a time period. As another example, the control information can indicate that power is to be purchased only if the cost is within 20% of the minimum cost for the time period, until a specified charge level is reached. As another example, the control information can indicate that power is to be purchased only if the cost is within a specified range of the identified minimum cost, unless a specified charge level is not reached by 5:00 am, at which point the battery 310 should be charged regardless of cost. As yet another example, the control information can indicate that power is to be sold whenever the cost is within 10% of the identified peak cost.

In instances in which the charging or discharging process of the battery 310 is ongoing, the controller 350 can determine the state of charge (SOC) of the battery 310 in real time. When the SOC of the battery 310 meets the conditions of the received configuration information (e.g., a specified charge capacity, a specified charge percentage, a specified monetary value of power sold or purchased, a specified charge/discharge duration elapsed, etc.), the controller 350 generates a control signal for stopping charging or discharging of the battery 310 and outputs the generated control signal to the battery charging/discharging management unit 360.

In instances in which the charging or discharging process of the battery 310 is ongoing, if the SOC of the battery 310 exceeds a first threshold value previously set for charging or is smaller than a second threshold value previously set for discharging, the controller 350 generates a control signal (including, for example, discharge control information, discharge stop information, and the like) for stopping charging or discharging of the battery 310 and outputs the generated control signal to the battery charging/discharging management unit 360.

Also, when a power selling (discharging) process of the battery 310 is ongoing, the controller 350 checks pre-set selling configuration conditions and controls discharging (or selling) of power charged in the battery 310 such that the SOC of the battery 310 meets the pre-set selling configuration conditions. For example, the controller 350 can control the transfer of power from the battery 310 to a charging unit or charging station such that a user specified dollar value of power is transferred. As another example, the controller 350 can control selling of power from the battery such that a user specified amount of power is sold, the battery 310 reaches a specified charge level, the battery 310 reaches a minimum charge level, or the battery 310 reaches a specified charge percentage.

The controller 350 can control the display unit 370 to display a user interface screen image or a graphic user interface screen image for setting the power transfer (e.g., charging or selling) configuration information, and configures the power transfer configuration information based on the user input. The controller 350 can calculate running information including information (including weather information, movement distance information according to a road state or the like) regarding a movement distance (or a running distance) using the battery 310 in a device such as a vehicle including the battery controlling apparatus 300. In this case, the running information may be calculated by a driving management system (or MCU) provided in the vehicle and the transmitted to the battery controlling apparatus 300 through the communication unit 330.

In some implementations, the display unit 370 can be included in a vehicle that includes the battery 310. In some implementations, the display unit 370 can be included in a charging unit engaged in power transfer functions (e.g., charging or discharging/selling) with the battery 310. In some implementations, the display unit 370 can be included in the terminal (e.g., a wireless device in communication with the controller 350 through the communication unit 330. In some implementations, the display unit 370 can be used to solicit power transfer control information from the user. The display unit 370 can prompt the user to enter charging or discharging parameters for charging or discharging of the battery 310. The control information can include a charge/discharge start time, a charge/discharge duration, an indication of a monetary value for an amount of power to transfer to or from the battery 310, an indication of a charge level to which the battery 310 is to be charged/discharged, an indication of a charge percentage (e.g., 95% of the total battery capacity) to which the battery 310 is to be charged/discharged, or an indication of an amount of power to transfer to or from the battery 310.

In some implementations, the display unit 370 can be configured to display information relating to a power transfer between the battery 310 and a charging unit. For example, in an implementation in which the display unit 370 is included in the terminal (e.g., a wireless device, or a communication terminal within the vehicle), the display unit 370 can indicate an amount of power transferred to or from the battery 310, a cost of power transferred to the battery 310 or sold from the battery 310, a present charge level of the battery 310, a distance that can be traveled based on the charge level of the battery, or a total charge/discharge duration of a power transfer function performed with respect to the battery 310.

Also, the controller 350 calculates gas mileage information regarding the battery controlling apparatus 300 based on the calculated charge information, running information, and the status information of the battery 310 or the like detected by the detection unit 320. In this case, the controller 350 may calculate gas mileage information according to a range previously set by the user such as an average gas mileage (e.g., a gas mileage according to a movement distance per 1 kw), a pre-set gas mileage of each section (e.g., a gas mileage per 10 km), a gas mileage of each date, a gas mileage of each weather type (e.g., a gas mileage according to weather such as rainy day, snowy day, sunny day, cloudy day, foggy day, and the like), a gas mileage of each road state (e.g., a gas mileage according to a road state such as driving downtown, driving on an expressway, driving in a mountainous area, paved/non-paved road driving, and the like). In this case, the information regarding weather or road state may be provided by the information providing center (or server) or a navigation device provided in the vehicle.

The controller 350 can check status information including information regarding an operational state (including, e.g., a charge operational state, a discharge (selling) operational state, and the like) in real time.

The controller 350 checks status information regarding an operational state or the like of each of one or more elements included in the vehicle. The one or more elements can include the battery controlling apparatus 300, a driving management system (or the M/G unit), a hydraulic control system, a brake control system (or the BCU) of the vehicle, a hybrid electric vehicle electronic control unit (HEV-ECU), or the like, in real time. In this case, the status information regarding the vehicle may be checked by the MCU provided in the vehicle and then transmitted to the battery controlling apparatus 300 through the communication unit 330.

The controller 350 can generate battery management information including the charge information, the selling information, the selling configuration information, the running information, the battery status information, the gas mileage information, the status information regarding the vehicle, and the like. In this case, the controller 350 may form a database with the units of information (including the charge information, the selling information, the selling configuration information, the running information, the battery status information, the gas mileage information, the status information regarding the vehicle, and the like) to generate battery management information and store the generated battery management information in the storage unit 340.

The battery charging/discharging management unit 360 performs charging or discharging (selling) through an external charging device connected with the battery controlling apparatus 300 based on a control signal (including, e.g., charge control information, charge stop information, discharge control information (or selling control information), discharge stop information (or selling stop information), and the like) generated by the controller 350.

In order to charge the battery 310 according to the control signal, the battery charging/discharging management unit 360 may include a converter unit (not shown) configured to receive commercial AC power supplied from the external charging device and convert the inputted commercial AC power into DC power by using a diode rectifier or the like, a smoothing unit (not shown) configured as a capacitor or a circuit including the capacitor, store and smooth the DC power outputted from the converter unit, and output the same to the battery 310, and a DC stabilizing unit (not shown) configured to uniformly maintain a DC link voltage based on an input voltage and an input current inputted to the smoothing unit and the DC link voltage outputted from the smoothing unit.

The DC stabilizing unit is connected between the converter unit and the smoothing unit. Here, the DC stabilizing unit may be disposed and connected in parallel between the converter unit and the smoothing unit in advance or may be provided independently in the form of an external device. When the DC stabilizing unit is configured as an external DC stabilizing unit, a general control device may include a slot or a connector so as to be used without connection of the DC stabilizing unit in an area where a normal voltage is supplied. In an area where there is a low voltage or input power is unstable, the DC stabilizing unit may be connected to be used.

The DC stabilizing unit may include a switching unit (not shown) for compensating the DC link voltage outputted to the battery 310 from the smoothing unit. Here, the switching unit may be an insulated gate bipolar transistor (IGBT) or an element having the same function as that of the IGBT. Also, the switching unit may be switched based on the detected DC link voltage to serve to uniformly maintain the voltage.

Also, when the battery 310 is discharged (or sold) according to the control signal, the battery charging/discharging management unit 360 converts DC power from the battery 310 into AC power, synchronizes the converted AC power to have the same phase as that of commercial AC power, generates the same frequency as that of the commercial AC power, and transmits the same to the external charging device.

In this manner, the battery charging/discharging management unit 360 performs functions such as performing AC/DC conversion or DC/AC conversion on power transmitted between the battery 310 and the external charging device when the battery 310 is charged or discharged.

The display unit 370 may display various contents such as various menu screen images by using the UI and/or GUI included in the storage unit 340 under the control of the controller 350. Here, the contents displayed on the display unit 370 may include a menu screen image including data such as various text or image data (including various information data), an icon, a list menu, a combo box, and the like.

The display unit 370 may display status information according to charging or discharging of the battery 310 under the control of the controller 350. The display unit 370 may display selling configuration information under the control of the controller 350 and receive a user input by using a touch screen scheme. The display unit 370 may display running information regarding the battery controlling apparatus 300 under the control of the controller 350.

Also, the display unit 370 may display the status information of the battery 310 including the SOC of the battery 310, the SOH, and the like, detected by the detection unit 320, the configuration information received through the communication unit 330, a communication connection state with the terminal, a connection state with the charging device, the status information regarding charging/discharging when the battery 310 is charged or discharged, the SOC, the SOH, or the like, of the battery 310, under the control of the controller 350.

The display unit 370 may display gas mileage information including an average gas mileage, a pre-set gas mileage of each section, gas mileage by date, gas mileage for various weather types, gas mileage for various road states, or the like. The display unit 370 may display the status information regarding the vehicle including a driving management system, a hydraulic control system, and a brake control system of the vehicle, and a hybrid electric vehicle electronic control unit (HEV-ECU) under the control of the controller 350.

The display unit 370 may display battery management information stored in a database under the control of the controller 350. The display unit 370 may include at least one of a Liquid Crystal Display (LCD), a Thin Film Transistor-LCD (TFT-LCD), an Organic Light Emitting Diode (OLED) display, a Field Emission Display (FED), a three-dimensional (3D) display, and a Light Emitting Diode (LED).

In some implementations, the battery controlling apparatus 300 may include two or more display units (or other display means). For example, a plurality of display units may be separately or integrally disposed on one surface (the same surface) of the mobile terminal, or may be separately disposed on mutually different surfaces.

Meanwhile, when the display unit 370 and a sensor (referred to as a ‘touch sensor’, hereinafter) for detecting a touch operation are overlaid in a layered manner to form a touch screen, the display unit 370 may function as both an input device and an output device. For example, the touch sensor may take the form of a touch film, a touch sheet, a touch pad, a touch panel, and the like.

Also, the touch sensor may be configured to convert pressure applied to a particular portion of the display unit 370 or a change in the capacitance or the like generated at a particular portion of the display unit 370 into an electrical input signal. The touch sensor may be configured to detect the pressure when a touch is applied, as well as the touched position and area. When there is a touch input with respect to the touch sensor, a corresponding signal (signals) are transmitted to a touch controller. The touch controller processes the signals and transmits corresponding data to the controller 350. Accordingly, the controller 350 may recognize which portion of the display unit 370 has been touched.

A proximity sensor may be disposed within the battery controlling apparatus 300 covered by the touch screen or near the touch screen. The proximity sensor is a sensor for detecting the presence or absence of an object relative to a certain detection surface or an object that exists nearby by using the force of electromagnetism or infrared rays without a physical contact. Thus, the proximity sensor has a considerably longer life span compared with a contact type sensor, and it can be utilized for various purposes.

Examples of the proximity sensor may include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

In this manner, when the display unit 370 is used as an input device, it may receive a command or a control signal according to a user's button manipulation or a manipulation such as touching or scrolling the displayed screen image.

The voice output unit 380 outputs voice information included in the signal processed by the controller 350. Here, the voice output unit 380 may be a speaker. The voice output unit 380 may output the status information of the battery 310 including the SOC of the battery 310, the SOH, and the like, detected by the detection unit 320, the configuration information received through the communication unit 330, a communication connection state with the terminal, a connection state with the charging device, status information regarding charging/discharging when the battery 310 is charged or discharged, or the like.

The voice output unit 380 can output running information according to the battery controlling apparatus 300 under the control of the controller 350. The voice output unit 380 may output gas mileage information including an average gas mileage, a pre-set gas mileage of each section, gas mileage of one or more dates, gas mileage for various weather types, gas mileage for various road states, or the like.

The voice output unit 380 may output the status information regarding the vehicle including status information for a driving management system, a hydraulic control system, and a brake control system of the vehicle, and a hybrid electric vehicle electronic control unit (HEV-ECU) under the control of the controller 350. The voice output unit 380 may output battery management information.

The charging device supplies commercial AC power to a connected certain device. The charging device selects a proper voltage and/or proper current based on a control signal (e.g., charge control information) transmitted from the battery controlling apparatus 300, and provides the selected proper voltage and/or proper current to the battery 310. Accordingly, the proper voltage and the proper current required for the battery 310 is charged in the battery 310.

The charging device may select the proper voltage and/or proper current based on the status information of the battery 310 transmitted from the battery controlling apparatus 300, and may provide the selected proper voltage and/or the proper current to the battery 310.

The charging device can stop charging the battery 310 based on a control signal (e.g., charge stop information) transmitted from the battery controlling apparatus 300. The charging device can charge power provided from the battery 310 to the charging device based on a control signal (e.g., discharge control information) transmitted from the battery controlling apparatus 300.

The charging device can stop drawing of power from the battery 310 based on a signal (e.g., discharge stop information) transmitted from the battery controlling apparatus 300. The charging device can direct power provided from the battery 310 to the charging device based on a control signal (e.g., selling control information) transmitted from the battery controlling apparatus 300. The charging device can stop the charging of power provided from the battery 310 based on a control signal (e.g., setting stop information) transmitted from the battery controlling apparatus 300.

The battery controlling apparatus 300 and the charging device may employ a smart grid system to supply power charged (or stored) in each device to mutually connected devices.

A battery control method according to an exemplary embodiment of the present invention will now be described with reference to FIGS. 3 to 8.

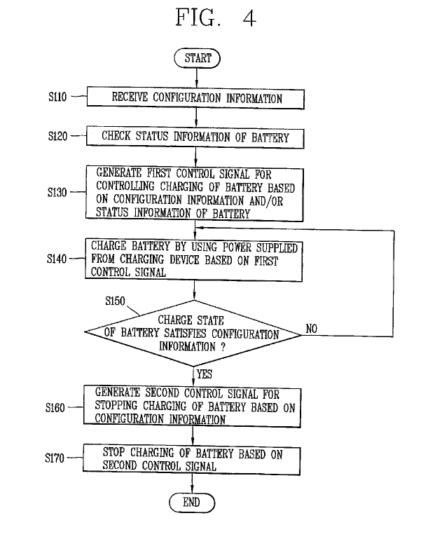

FIG. 4 is a flow chart showing a method for controlling a battery according to a first exemplary embodiment of the present invention. In the present exemplary embodiment, the battery controlling apparatus 300 can be provided in the vehicle. Alternatively, the battery controlling apparatus 300 can be applicable to any device that uses a battery, as well as to the vehicle.

First, the communication unit 330 may receive configuration information transmitted from a certain terminal connected with the battery controlling apparatus 300 through a certain communication network. In this case, the certain terminal may be a mobile terminal, a telematics terminal, a smartphone, a personal information terminal, a PMP terminal, a computer, a WiBro terminal, an IPTV terminal, a navigation terminal, an AVN terminal, an A/V system, and the like. The certain communication network may be a CAN, i.e., a vehicle network system, or a short-range communication network when the battery controlling apparatus 300 is provided in the vehicle or the like. Namely, the battery controlling apparatus 300 and the certain terminal may be connected through the CAN, and the certain terminal may be connected with an external certain terminal, an information providing center, a call center, or the like, through a wireline/wireless communication network.

The configuration information may include a charge duration (including a total charge duration, a reservation charge start time, a reservation charge end time, etc.), a charge amount, and a charge fee for charging the battery 310. The configuration information may be outputted through the display unit 370 and/or the voice output unit 380 under the control of the controller 350 (S110).

Thereafter, the detection unit 320 may detect the state of charge (SOC) of the battery 310. The detection unit 320 may detect the voltage and/or current of each cell of the battery 310, and calculate the SOC based on the detected voltage value and/or current value. The detection unit 320 may detect temperature information of the battery 310 (including the temperature within the battery 310, ambient temperature, and the like).

The status information for the battery 310 can include a state of charge (SOC), a voltage value, a current value, temperature information, and the like. The status information for the battery 310 may further include unique information for the battery 310. In this case, the unique information for the battery 310 may include at least one of a rated capacity, a rated voltage, and a rated current of a reference battery.

The status information of the battery 310 may be outputted through the display unit 370 and/or the voice output unit 380 under the control of the controller 350 (S120).

Thereafter, the controller 350 generates a first control signal (including, e.g., charge control information) for controlling charging of the battery 310 based on the received configuration information and/or the status information of the battery 310.

For example, when a charge duration (e.g., a total charge duration) is included in the received configuration information and the total charge duration is set to be two hours, the controller 350 generates the first control signal for controlling charging of the battery 310 based on a time point at which the configuration information is received or at a pre-set time point (e.g., 1:00 a.m. every day, 2:00 a.m. every Wednesday, etc).

In instances in which the received configuration information includes a charge duration and a reservation charge start time, the controller 350 can identify the current time. When the current time is consistent with the reservation charge start time, the controller 350 generates the first control signal for controlling charging of the battery 310.

In instances in which the received configuration information includes a charge duration (e.g., a total charge duration is set to be three hours) and the state of charge of the battery 310 is smaller than a pre-set first state of charge (e.g., a pre-set maximum state of charge, 95 percent of the rated capacity of the battery 310, a maximum value of the rated capacity of the battery 310, etc.), the controller 350 generates the first control signal for controlling charging of the battery 310 based on the time point at which the configuration information is received or a pre-set time point.

As another example, when the received configuration information includes a charge amount (e.g., 10 kw) and the state of charge of the battery 310 is less than the pre-set first state of charge, the controller 350 generates the first control signal for charging the battery 310. As yet another example, when the received configuration information includes a charge fee (e.g., 20 dollars), the controller generates the first control signal for charging power corresponding to the charge fee to the battery 310 based on power fee information (e.g., 0.1 dollar per kw) previously stored in the storage unit 340.

In some instances in which the received configuration includes the charge fee and the state of charge of the battery 310 is les than the pre-set first state of charge, the controller 350 generates the first control signal for charging the battery 310 in accordance with the charge fee.

In the examples, the respective cases of the charge duration, the charge amount, and the charge fee have been described, but two or more of the charge duration, the charge amount, and the charge fee may be combined to generate a control signal for controlling charging of the battery 310. In this case, when two or more of the elements are combined, the controller 350 may generate a control signal for controlling charging of the battery 310 based on a pre-set priority of each element (S130).

Thereafter, the battery charging/discharging management unit 360 converts power supplied to the external charging device connected with the battery controlling apparatus 300 based on the first control signal (including, e.g., the charge control information) generated by the controller 350, and supplies the same to the battery 310. Namely, the battery charging/discharging management unit 360 performs conversion (including an AC/DC conversion) such as rectifying or smoothing of commercial AC power supplied from the external charging device, and charges the battery 310 by using the converted DC power. In this case, the battery charging/discharging management unit 360 may include a first switch unit (not shown) between an output stage of the converted DC power and the battery 310. In instances in which the battery 310 is being charged, the first switch unit may be turned on based on the first control signal to allow the outputted DC power to be supplied to the battery 310. Also, the first switch unit may be turned off in other cases than charging the battery 310, to cut off the connection between the battery 310 and the external charging device.

For example, when the first control signal is generated based on the charge duration (e.g., a total charge duration: two hours), the battery charging/discharging management unit 360 may convert the commercial AC power provided from the external charging device based on the first control signal to provide the converted power to the battery 310, thus charging the battery 310.

Also, when the first control signal is generated based on the charge duration (e.g., when the reservation charge start time is set to be 2:00 a.m.), the battery charging/discharging management unit 360 converts the commercial AC power provided from the external changing device at the corresponding time point (i.e., the reservation charge start time) and supplies the converted power to the battery 310 to charge it.

When the first control signal is generated based on the charge duration (e.g., a total charge duration: three hours) and the state of charge of the battery 310, the battery charging/discharging management unit 360 converts the commercial AC power provided from the external charging device and supplies the converted power to the battery 310 to charge it based on the first control signal.

As another example, when the first control signal is generated based on the charge amount (e.g., 10 kw) and the state of charge of the battery 310, the battery charging/discharging management unit 360 converts the commercial AC power provided from the external charging device and supplies the converted power to the battery 310 to charge it based on the first control signal.

As yet another example, when the first control signal is generated based on the charge fee (e.g., 20 dollars), the battery charging/discharging management unit 360 converts the commercial AC power provided from the external charging device and supplies the converted power to the battery 310 to charge it based on the first control signal. As another example, when the first control signal is generated based on the charge fee and the state of charge of the battery 310, the battery charging/discharging management unit 360 converts the commercial AC power provided from the external charging device and supplies the converted power to the battery 310 to charge it based on the first control signal.

In this manner, the battery 310 is charged with power provided from the certain charging device based on the first control signal generated by the controller 350.

In the foregoing example as described above, the battery controlling apparatus 300 and the certain charging device are directly connected by an element such as a power consent, but the battery controlling apparatus 300 and the certain charging device may include transmission and reception units, respectively, and the battery 310 may be charged by using one of a magnetic resonance coupling method, an electromagnetic induction method, and a radiowave method between the transmission and reception units. Namely, the battery controlling apparatus 300 and the certain charging device may be configured to charge the battery 310 wirelessly, and when charging is wirelessly performed, the configuration of the reception unit and the transmission unit may be easily designed by a person skilled in the art to perform their functions (S140).

Thereafter, the controller 350 checks the state of charge of the battery 310 in real time and determines whether or not the charge of state of the battery 310 satisfies the configuration information. The controller 350 may output information including the state of charge of the battery 310 checked in real time, a communication connection state, and the like, through the display unit 370 and/or the voice output unit 380 (S150).

Thereafter, when the state of charge of the battery 310 satisfies the configuration information, the controller 350 generates a second control signal (including e.g., charge stop information) for stopping charging of the battery 310 based on the configuration information. For example, when a charge duration (e.g., a total charge duration) is included in the received configuration information and the total charge duration is set to be two hours, the controller 350 generates the second control signal for stopping charging of the battery 310 when the pre-set two hours lapses from a time point at which the charging has started.

Also, when the received configuration information includes a charge duration (a reservation charge end time) and the reservation charge end time is 6:00 a.m., the controller 350 checks a current time. When the checked current time is consistent with the reservation charge end time, the controller 350 generates the second control signal for stopping charging of the battery 310.

As another example, when the received configuration information includes a charge amount (e.g., 10 kw), the controller 350 checks the charge state of the battery 310 in real time. When the checked state of charge of the battery 310 has I is equal to the indicated charge amount, the controller 350 generates the second control signal for stopping charging of the battery 310.

For still another example, when the received configuration information includes a charge fee (e.g., 20 dollars), the controller checks the charge state of the battery 310 in real time. When the usage fee (or the charge fee) according to the checked state of charge of the battery 310 is the same as the set charge fee, the controller 350 generates the second control signal for stopping charging of the battery 310.

In some instances, while the battery 310 is being charged based on the received configuration information (including the charge duration, the charge amount, the charge fee, and the like), if the state of charge of the battery 310 exceeds a pre-set first state of charge (e.g., a pre-set maximum state of charge, 95 percent of the rated capacity of the battery 310, a maximum value of the rated capacity of the battery 310, etc.), the controller 350 generates the second control signal for stopping charging of the battery 310 regardless of the received configuration information. For example, in a state in which a total charge duration included in the received configuration information is set to be two hours and charging has been ongoing for about 30 minutes, when the state of charge of the battery 310 exceeds 95 percent of the pre-set rated capacity of the battery 310, the controller 350 generates the second control signal for stopping charging of the battery 310. With this configuration, over-charging of the battery 310 can be prevented (S160).

Thereafter, the battery charging/discharging management unit 360 cuts off the connection between the external charging device and the battery controlling apparatus 300 in order to stop charging of the battery 310 by the external charging device based on the second control signal (including, e.g., the charge stop information) generated by the controller 350. Namely, the battery charging/discharging management unit 360 turns off the first switch unit based on the second control signal to cut off interconnection between the battery 310 and the external charging device (S170).

In this manner, the battery 310 can be charged by using the power supplied from the certain charging device based on the configuration information and/or the status information of the battery 310.

Configuration information transmitted from an external source may be received through a communication module such as a telematics module (or a telematics terminal) interworking with the battery controlling apparatus 300. The battery 310 may be charged by using power supplied from the certain charging device based on the received configuration information. The commercial AC power supplied from the certain charging device can be AC/DC converted and the converted power can be charged to the battery 310 based on the control signal generated by the battery controlling apparatus.

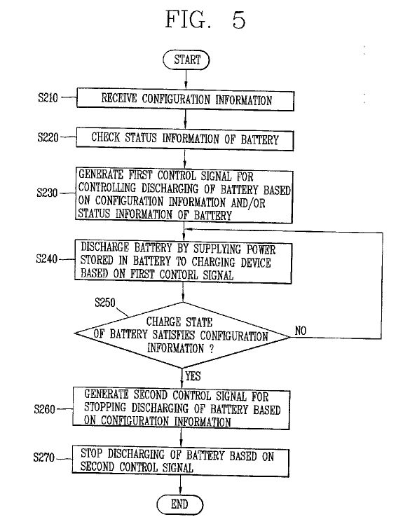

FIG. 5 is a flow chart showing a method for controlling a battery according to a second exemplary embodiment of the present invention.

First, the communication unit 330 receives configuration information transmitted from a certain terminal connected with the battery controlling apparatus 300 through a certain communication network. In this case, the certain terminal may be a mobile terminal, a telematics terminal, a smart phone, a portable terminal, a personal digital assistant (PDA), a portable multimedia player (PMP) terminal, a computer, a WiBro terminal, an Internet protocol television (IPTV) terminal, a navigation terminal, an audio video navigation (AVN) terminal, an A/V system, and the like. In instances in which the battery controlling apparatus 300 is provided in a vehicle or the like, the certain communication network may be a controller area network (CAN), i.e., a vehicle network system, or a short-range communication network. Namely, the battery controlling apparatus 300 and the certain terminal may be interconnected through the CAN, and the certain terminal may be interconnected with another external certain terminal, an information providing center, a call center, or the like, through a wireline/wireless communication network.

The configuration information may include at least one of a discharge duration (including a total discharge duration, a reservation discharge start time, a reservation discharge end time, and the like), a discharge amount, and a discharge fee for discharging the battery 310. The received configuration information may be outputted through the display unit 370 and/or the voice output unit 380 under the control of the controller 350 (S210).

Thereafter, the detection unit 320 detects a state of charge (SOC) of the battery 310. The detection unit 320 may detect a voltage and/or current of each cell of the battery 310 and calculate the state of charge (SOC) based on the detected voltage value and/or current value.

The detection unit 320 can detect temperature information (including the temperature within the battery 310 and the temperature of the surrounding environment) of the battery 310.

The status information for the battery 310 can include a state of charge (SOC), a voltage value, a current value, temperature information, and the like. The status information for the battery 310 may further include unique information for the battery 310. In this case, the unique information for the battery 310 may include at least one of a rated capacity, a rated voltage, and a rated current of a reference battery. The status information of the battery 310 may be outputted through the display unit 370 and/or the voice output unit 380 under the control of the controller 350 (S220).

Thereafter, the controller 350 generates a first control signal (including, e.g., discharge control information) for controlling discharging of the battery 310 based on the received configuration information and/or the status information of the battery 310.

For example, when a discharge duration (e.g., a total discharge duration) is included in the received configuration information and the total discharge duration is set to be two hours, the controller 350 generates the first control signal for controlling discharging of the battery 310 based on a time point at which the configuration information is received or a pre-set time point (e.g., 1:00 a.m. every day, 2:00 a.m. every Wednesday, etc).

Additionally, if the received configuration information includes a discharge duration (a reservation discharge start time) and the reservation discharge start time is 3:00 a.m., the controller 350 can check a current time. When the checked current time is consistent with the reservation discharge start time, the controller 350 generates the first control signal for controlling discharging of the battery 310.

In instances in which the received configuration information includes a discharge duration (e.g., a total discharge duration is set to be one hour) and the state of charge of the battery 310 is greater than a pre-set second state of charge (e.g., a pre-set maximum state of charge, 30 percent of the rated capacity of the battery 310, a minimum value of the rated capacity of the battery 310, etc.), the controller 350 generates the first control signal for controlling discharging of the battery 310 based on the time point at which the configuration information is received or the pre-set time point.

As another example, when the received configuration information includes a discharge amount (e.g., 5 kw) and the state of charge of the battery 310 is smaller than the pre-set first state of charge, the controller 350 generates the first control signal for charging the battery 310.

As still another example, when the received configuration information includes a discharge fee (e.g., 30 dollars), the controller generates the first control signal for discharging power corresponding to the discharge fee based on power fee information (e.g., 0.12 dollar per kw) previously stored in the storage unit 340. Also, when the received configuration includes the discharge fee and the state of charge of the battery 310 is greater than the pre-set second state of charge, the controller 350 generates the first control signal for discharging the battery 310 by the discharge fee.

In these examples, the respective cases of the discharge duration, the discharge amount, and the discharge fee have been described, but two or more of the discharge duration, the discharge amount, and the discharge fee may be combined to generate a control signal for controlling discharging of the battery 310. In this case, when two or more of the elements are combined, the controller 350 may generate a control signal for controlling discharging of the battery 310 based on a pre-set priority of each element (S230).

Thereafter, the battery charging/discharging management unit 360 converts power charged in the battery 310 based on the first control signal (including, e.g., the discharge control information) generated by the controller 350, and supplies the same to the external charging device connected with the battery controlling apparatus 300. Namely, the battery charging/discharging management unit 360 performs certain conversion (including a DC/AC conversion) on power charged in the battery 310, and supplies the converted AC power to the external charging device. In this case, the battery charging/discharging management unit 360 may include a second switch unit (not shown) between an output stage of the converted AC power and the external charging device. When the battery is being discharged, the second switch unit may be turned on based on the first control signal to allow the outputted AC power to be supplied to the external charging device. Also, the second switch unit may be turned off in other cases than discharging the battery, to cut off the connection between the battery 310 and the external charging device.

For example, when the first control signal is generated based on the discharge duration (e.g., a total charge duration: two hours), the battery charging/discharging management unit 360 may convert (e.g., DC/AC conversion) power charged in the battery 310 based on the first control signal to provide the converted power to the external charging device, thus discharging the battery 310.

In instances in which the first control signal is generated based on the charge duration (e.g., when the reservation discharge start time is set to be 3:00 p.m.), the battery charging/discharging management unit 360 converts power charged in the battery 310 at the corresponding time point (i.e., the reservation charge start time) and supplies the converted power to the external charging device.

Also, when the first control signal is generated based on the discharge duration (e.g., a total discharge duration: one hour) and the first control signal is generated based on the state of charge of the battery 310, the battery charging/discharging management unit 360 converts power stored in the battery 310 and supplies the converted power to the external charging device based on the generated first control signal.

As another example, when the first control signal is generated based on a discharge amount (e.g., 5 kw), and the state of charge of the battery 310, the battery charging/discharging management unit 360 converts power charged in the battery 310 and supplies the converted power to the external charging device to discharge the battery 310, based on the first control signal.

As another example, when the first control signal is generated based on a discharge fee (e.g., 30 dollars), the battery charging/discharging management unit 360 converts power charged in the battery 310 and supplies the converted power to the external charging device to discharge the battery 310, based on the first control signal.

As yet another example, when the first control signal is generated based on the discharge fee and the state of charge of the battery 310, the battery charging/discharging management unit 360 converts power charged in the battery 310 and supplies the converted power to the external charging device based on the first control signal.

In this manner, the battery 310 supplies power charged in the battery 310 to the external charging device based on the first control signal generated by the controller 350.

In the foregoing examples as described above, the battery controlling apparatus 300 and the certain charging device are directly connected by an element such as a power consent, but the battery controlling apparatus 300 and the certain charging device may include transmission and reception units, respectively, and power of the battery 310 may be supplied to the external charging device by using one of a magnetic resonance coupling method, an electromagnetic induction method, and a radiowave method between the transmission and reception units. Namely, the battery controlling apparatus 300 and the certain charging device may be configured to charge the battery 310 wirelessly, and when charging is wirelessly performed, the configuration of the reception unit and the transmission unit may be easily designed by a person skilled in the art to perform their functions (S240).

Thereafter, the controller 350 checks the state of charge of the battery 310 in real time and determines whether or not the charge state of the battery 310 satisfies the configuration information. The controller 350 may output information including the state of charge of the battery 310 checked in real time, a communication connection state, or the like, through the display unit 370 and/or the voice output unit 380 (S250).

Thereafter, when the state of charge of the battery 310 satisfies the configuration information, the controller 350 generates a second control signal (including e.g., discharge stop information) for stopping discharging of the battery 310 based on the configuration information.

For example, when a discharge duration (e.g., a total charge or discharge duration) is included in the received configuration information and the total discharge duration is set to be two hours, the controller 350 generates the second control signal for stopping discharging of the battery 310 when the pre-set two hours lapses from a time point at which the charging has started.

Also, when the received configuration information includes a discharge duration (a reservation discharge end time) and the reservation discharge end time is 5:00 p.m., the controller 350 checks a current time. When the checked current time is consistent with the reservation discharge end time, the controller 350 generates the second control signal for stopping discharging of the battery 310.

As another example, when the received configuration information includes a discharge amount (e.g., 5 kw), the controller 350 checks the charge state of the battery 310 in real time. When the checked state of charge of the battery 310 has been discharged by the discharge amount, the controller 350 generates the second control signal for stopping discharging of the battery 310.

As still another example, when the received configuration information includes a discharge fee (e.g., 30 dollars), the controller checks the charge state of the battery 310 in real time. When the usage fee (or the discharge fee) according to the checked state of charge of the battery 310 is the same as the set discharge fee, the controller 350 generates the second control signal for stopping discharging of the battery 310.

In some cases, while the battery 310 is being discharged based on the received configuration information (including the discharge duration, the discharge amount, the discharge fee, and the like), if the state of charge of the battery 310 is smaller than a pre-set second state of charge (e.g., a pre-set minimum state of charge, 30 percent of the rated capacity of the battery 310, a minimum value of the rated capacity of the battery 310, etc.), the controller 350 generates the second control signal for stopping discharging of the battery 310 regardless of the received configuration information. For example, in a state that a total discharge duration included in the received configuration information is set to be one hour and discharging has been ongoing for about 20 minutes, when the state of charge of the battery 310 is smaller than 30 percent of the pre-set rated capacity of the battery 310, the controller 350 generates the second control signal for stopping discharging of the battery 310. With this configuration, complete discharging of the battery 310 can be prevented (S260).

Thereafter, the battery charging/discharging management unit 360 cuts off the connection between the external charging device and the battery controlling apparatus 300 in order to stop discharging to the external charging device from the battery 310 based on the second control signal (including, e.g., the discharge stop information) generated by the controller 350. Namely, the battery charging/discharging management unit 360 turns off the second switch unit based on the second control signal to cut off interconnection between the battery 310 and the external charging device (S270).

In this manner, power charged in battery 310 can be supplied to the to certain charging device based on the status information of the battery 310.

Configuration information transmitted from an external source may be received through a communication module such as a telematics module (or a telematics terminal) interworking with the battery controlling apparatus 300, and then power stored in the battery 310 may be supplied to the certain charging device based on the received configuration information.

The power stored in the battery 310 can be DC/AC converted and the converted power can be supplied to the certain charging device based on the control signal generated by the battery controlling apparatus.

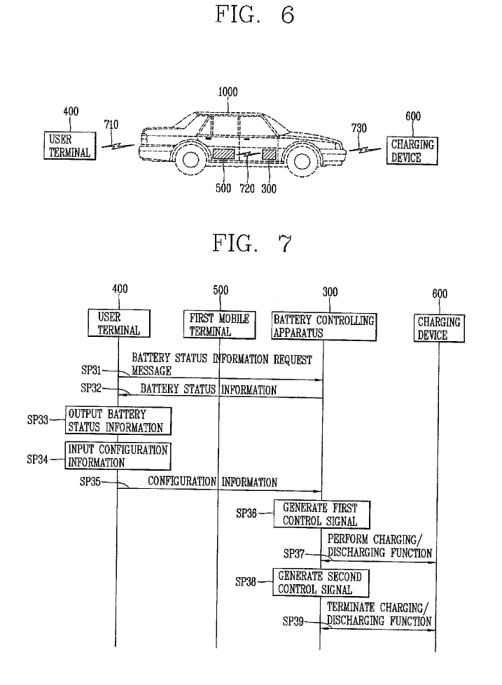

FIG. 6 is a schematic block diagram showing the configuration of a system for controlling a battery according to an exemplary embodiment of the present invention. The battery controlling system 10 includes a user terminal 400, the battery controlling apparatus 300 and a first mobile terminal 500 provided in a vehicle 1000, and a charging device 600.

The user terminal 400 may be one of an information providing center, a call center, and a second mobile terminal. The second mobile terminal may be one of a mobile terminal, a telematics terminal, a smartphone, a personal information terminal, a PMP terminal, a computer, a WiBro terminal, an IPTV terminal, a navigation terminal, an AVN terminal, an A/V system, and the like.

Also, the user terminal 400 may transmit configuration information inputted by the user in the format of voice data or text data and transmit the same to the first mobile terminal 500.

The user terminal 400 may send a request to the battery controlling apparatus connected with the first mobile terminal 500 requesting that the battery controlling apparatus 300 transmit status information of the battery 310 included in the battery controlling apparatus 300, and output the status information of the battery 310 transmitted from the battery controlling apparatus 300 in response to the request through a display unit (not shown) included in the user terminal 400 and a voice output unit (not shown). In this case, the status information of the battery may include at least one of a state of charge (SOC) of the battery 310, a voltage value, a current value, temperature information (including the temperature within the battery 310 and the temperature of the surrounding environment) of the battery 310, and unique information of the battery 310 previously stored in the storage unit 330. The unique information of the battery may include at least one of a rated capacity, a rate voltage, and a rated current of a reference battery.

In some cases, in order to authenticate the battery controlling apparatus 300, the user terminal 400 may request the battery controlling apparatus 300 to transmit information of the battery controlling apparatus 300 or vehicle information of the vehicle 1000 in which the battery controlling apparatus 300 is provided, and authenticate the battery controlling apparatus 300 based on the information transmitted from the battery controlling apparatus 300 in response to the request. When the authentication is normally performed, the user terminal 400 may generate a signal indicating that the authentication has been normally performed, and transmit the generated signal to the battery controlling apparatus 300 through the first mobile terminal 500. Namely, an authentication procedure may be performed between the user terminal 400 and the battery controlling apparatus 300 (or between the user terminal 400 and the first mobile terminal 500).

Also, the user terminal 400 and the first mobile terminal 500 may be interconnected through wireline or wireless communication method 710. In this case, the wireline/wireless communication method 710 may include a wireless local area network (WLAN), Wi-Fi, wireless broadband (WiBro), world interoperability for microwave access (WiMAX), high speed downlink packet access (HSDPA), a long term evolution (LTE), IEEE 802.16, a wireless mobile broadband service (WMBS), Bluetooth™, Radio Frequency IDentification (RFID), Infrared Data Association (IrDA), Ultra-WideBand (UWB), ZigBee™ and the like.

The first mobile terminal 500 is provided within the vehicle 1000 and interconnected with the battery controlling apparatus 300. In this case, the first mobile terminal 500 and the battery controlling apparatus 300 may be interconnected by a CAN 720, a vehicle network system.

The first mobile terminal 500 and the battery controlling apparatus 300 may be also connected through a short-range communication method 720 such as Bluetooth™, Radio Frequency IDentification (RFID), Infrared Data Association (IrDA), Ultra-WideBand (UWB), ZigBee™.

Also, the first mobile terminal 500 may receive configuration information, other control signals, or the like, transmitted from the user terminal 400, and transmit the received signals to the battery controlling apparatus 300 through the CAN. The first mobile terminal 500 may be one of certain terminals such as a mobile terminal, a telematics terminal, a smart phone, a portable terminal, a personal digital assistant (PDA), a portable multimedia player (PMP) terminal, a computer, a WiBro terminal, an Internet protocol television (IPTV) terminal, a navigation terminal, an audio video navigation (AVN) terminal, an A/V system.

The battery controlling apparatus 300 may charge power supplied from the charging device 600 to the battery 310 or supply power charged in the battery 310 to the charging device 600. The charging device 600 may supply power charged in the charging device 600 to the battery 310 or may be provided with power charged in the battery 310 based on a control signal generated by the battery controlling apparatus 300.

In some implementations, the charging device 600 can be included in a charging station. The charging station can be, for example, located in a user's home or garage. As another example, the charging station can be a public charging station (e.g., located at a travel plaza or on a street for public use). In some implementations, the charge device 600 or a charging station that includes the charge device 600 can include a meter for measuring an amount of power charged to or discharged from the battery 310. In some implementations, the charging station can perform one or more of the functions described above with respect to the battery controlling apparatus 300. For example, in some implementations, the charging device 600 can include a unit for identifying battery status information of a battery of the vehicle 1000. As another example, the charging device 600 can generate control signals for controlling of power transfer functions with respect to transferring power from the charging device 600 to the battery 310 or from the battery 310 to the charging device 600. The charging device 600 can include a wireless communications unit for establishing wireless communications with the vehicle 1000 and/or the user terminal 400.

In some implementations, characteristics of the charge device 600 or a charging station that includes the charge device 600 can be identified. For example, a communication ID or address for the charge device 600 can be identified. As another example, a power charging or discharging rate of the charge device 600 can be identified. As another example, a cost of power sold by or sold to the charge device 600 can be identified. As yet another example, a business entity associated with the charge device 600 can be identified (e.g., the business entity that is paid or charged for a power transfer function with respect to the battery 310).

In some implementations, additional characteristics of the charge device 600 can be identified, such as peak, average, and minimum power costs for a specified time period. As described above, the cost of power transferred to or from the charge device 600 can be identified and recorded at regular intervals (e.g., every 30 seconds) for a given period of time (e.g., 24 hours). This information can be used to identify peak, average, and minimum power costs for the time period. Control signals can be generated (either by the charge device 600, the battery controlling apparatus 300, or the terminal 400) based on a present cost of power with relation to an identified peak, average, or minimum power cost for a given time period.

For example, the charge device 600 can generate a control signal to indicate that a charging function is to occur when the present cost of power is at or below the identified average cost. As another example, the battery controlling apparatus 300 can generate a control signal to initiate a power selling function when the present power cost is within $0.30 per KW of the identified peak cost.

FIG. 7 is a signal flow chart showing a communication process of the system for controlling a battery according to a third exemplary embodiment of the present invention.

First, the user terminal 400 transmits a status information request message for the battery 310 included in the battery controlling apparatus 300 to the first mobile terminal 500. The first mobile terminal 500 receives the status information request message for the battery 310 transmitted from the user terminal 400, and transmits (or forwards) the received status information request message for the battery 310 to the battery controlling apparatus 300.

A mutual authentication process may be additionally performed between the user terminal 400 and the first mobile terminal 500 or between the user terminal 400 and the battery controlling apparatus 300 (SP31).

Thereafter, the first mobile terminal 500 receives a signal including status information of the battery transmitted from the battery controlling apparatus 300 in response to the status information request message of the battery, and transmits the received signal including the status information of the battery to the user terminal 400. In this case, the status information of the battery may include at least one of a state of charge (SOC) of the battery 310, a voltage value, a current value, temperature information (including the temperature within the battery 310 and the temperature of the surrounding environment) of the battery 310, and unique information of the battery 310 previously stored in the storage unit 340. The unique information of the battery may include at least one of a rated capacity, a rate voltage, and a rated current of a reference battery (SP32).

Thereafter, the user terminal 400 receives the signal including the status information of the battery transmitted from the first mobile terminal 500 and outputs the status information included in the received signal through the display unit and/or the voice output unit included in the user terminal 400 (SP33).

Thereafter, the user terminal 400 receives configuration information according to a user input. In this case, the configuration information may include at least one of a charge duration, a charge amount, a charge fee, a discharge duration, a discharge amount, and a discharge fee, and information regarding priority of each of the charge duration, the charge amount, the charge fee, the discharge duration, the discharge amount, and the discharge fee may be additionally set (SP34).

Thereafter, the user terminal 400 transmits the inputted configuration information to the battery controlling apparatus 300 through the first mobile terminal 500 (SP35).

The battery controlling apparatus 300 generates the first control signal (including, e.g., charge control information, discharge control information, and the like) for charging or discharging the battery 310 based on the received configuration information and/or the status information of the battery 310 (SP36).

The battery controlling apparatus 300 controls the battery charging/discharging management unit 360 based on the generated first control signal to perform a charging or discharging function between the battery 310 and the charging device 600 (SP37).

Thereafter, while charging or discharging function is performed between the battery 310 and the charging device 600, the battery controlling apparatus 300 checks the state of charge (SOC) of the battery 310 in real time. If it is determined that the checked state of charge of the battery 310 meets the conditions of the received configuration information, the battery controlling apparatus 300 generates the second signal (e.g., charge stop, discharge stop, and the like) for stopping charging or discharging between the battery 310 and the charging device 600.

While charging or discharging function is performed between the battery 310 and the charging device 600, the battery controlling apparatus 300 checks the state of charge (SOC) of the battery 310 in real time. If it is determined that the checked state of charge of the battery 310 exceeds the pre-set first state of charge (e.g., a pre-set maximum state of charge, 95 percent of the rated capacity of the battery 310, a maximum value of the rated capacity of the battery 310, etc.) or is less than the pre-set second state of charge (e.g., a pre-set minimum state of charge, 30 percent of the rated capacity of the battery 310, a minimum value of the rated capacity of the battery 310, etc.), the battery controlling apparatus 300 may generate the second control signal (e.g., charge stop, discharge stop, and the like) for stopping charging or discharging between the battery 310 and the charging device 600 (SP38).

The battery controlling apparatus 300 controls the battery charging/discharging management unit 360 based on the generated second control signal to stop charging or discharging function between the battery 310 and the charging device 600 (SP39).

In this manner, the configuration information transmitted from an external source may be received through the terminal (i.e., the first mobile terminal) provided in the vehicle, charging or discharging is performed between the battery provided in the vehicle and the charging device connected with the battery based on the received configuration information and/or the status information of the battery, whereby charging or discharging of the battery can be performed remotely.

In some implementations, the battery controlling apparatus 300 and the charging device 600 can configure a single smart grid system, and power may be mutually transmitted (or supplied) between the battery controlling apparatus 300 and the charging device 600 included in the smart grid system according to the remotely transmitted configuration information.

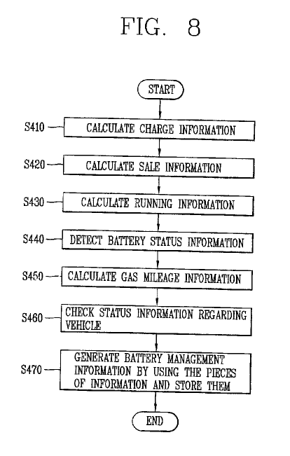

FIG. 8 is a flow chart showing a method for controlling a battery according to a fourth exemplary embodiment of the present invention.

When a charge event with respect to the battery 310 occurs, the controller 350 generates a first control signal for charging the battery 310 and outputs it. A charge event can occur, for example, where one or more conditions included in first configuration information are satisfied based on the first configuration information including one or more of a first charge duration (including a total charge duration, a reservation charge start time, a reservation charge end time, and the like), a first charge amount, and a first charge fee for charging the battery 310. When a charge event with respect to the battery 310 occurs, the controller 350 generates a first control signal. In this case, the first control information may be set by the display unit 370 of the battery controlling apparatus 300 or according to a user input or may be transmitted from a certain terminal connected with the battery controlling apparatus 300 through a certain communication network. Here, the certain terminal may be a mobile terminal, a telematics terminal, a smart phone, a portable terminal, a personal digital assistant (PDA), a portable multimedia player (PMP) terminal, a computer, a WiBro terminal, an Internet protocol television (IPTV) terminal, a navigation terminal, an audio video navigation (AVN) terminal, an A/V system, an information providing center, a call center, a server, and the like. The terminal may be provided within a certain vehicle including a certain battery. Also, the certain communication network may include a wireless local area network (WLAN), Wi-Fi, wireless broadband (WiBro), world interoperability for microwave access (WiMAX), high speed downlink packet access (HSDPA), a long term evolution (LTE), IEEE 802.16, a wireless mobile broadband service (WMBS), a power line communication (PLC), and the like, e.g., a wireline/wireless communication scheme. Also, the short-range communication technique may include Bluetooth™, Radio Frequency IDentification (RFID), Infrared Data Association (IrDA), Ultra-WideBand (UWB), ZigBee™, and the like.

Thereafter, the battery charging/discharging management unit 360 converts power supplied from an external charging device connected with the battery controlling apparatus 300 and supplies the same to the battery 310 based on the first control signal (including, e.g., charge control information) generated by the controller 350. Namely, the battery charging/discharging management unit 360 performs certain conversion (including an AC/DC conversion) such as rectifying or smoothing on commercial AC power supplied from the external charging device, and charges the battery 310 by using the converted DC power. In this case, the battery charging/discharging management unit 360 may include a first switch unit (not shown) between an output stage of the converted DC power and the battery 310. In situations in which the battery 310 is being charged, the first switch unit may be turned on based on the first control signal to allow the outputted DC power to be supplied to the battery 310. Also, the first switch unit may be turned off in other cases than charging the battery 310, to cut off the connection between the battery 310 and the external charging device.

In some instances, the battery controlling apparatus 300 and the external charging device may be directly connected by an element such as a power consent, or the battery controlling apparatus 300 and the external charging device may include transmission and reception units, respectively, and the battery 310 may be charged by using one of a magnetic resonance coupling method, an electromagnetic induction method, and a radiowave method between the transmission and reception units. Namely, the battery controlling apparatus 300 and the certain charging device may be configured to charge the battery 310 wirelessly, and when charging is wirelessly performed, the configuration of the reception unit and the transmission unit may be easily designed by a person skilled in the art to perform their functions.

The controller 350 may calculate charge information including one or more of a charge time, a charge amount, and a charge fee of the actually charged battery 310. Here, the calculated charge fee is a rate (e.g., ten dollars) corresponding to the charge amount (e.g., 100 kw) according to charging of the battery 310 based on power rate information (e.g., 0.1 dollar per kw). In some implementations, the controller 350 stores information regarding the number of times of charging as the battery 310 is charged in the storage unit 340.

The controller 350 may output information including the charge state, a communication connection state, and the like of the battery 310 as checked in real time through the display unit 370 and/or the voice output unit 380 (S410).

Thereafter, when a discharge (or selling) event with respect to the battery 310 occurs, the controller 350 generates a second control signal for discharging power (or voltage) charged in the battery 310 and outputs the same. Namely, when a discharge event with respect to the battery 310 occurs (e.g., one or more conditions included in second configuration information are satisfied based on the second configuration information including one or more of a second discharge duration (including a total discharge duration, a reservation discharge start time, a reservation discharge end time, and the like), a second discharge amount, and a second discharge fee for discharging to the battery 310) the controller 350 generates a second control signal. In this case, the second control information may be set by the display unit 370 of the battery controlling apparatus 300 or according to a user input or may be transmitted from a certain terminal connected with the battery controlling apparatus 300

Thereafter, the battery charging/discharging management unit 360 converts power charged in the battery 310 based on the second control signal (including, e.g., selling control information) generated by the controller 350, and supplies the same to the external charging device connected with the battery controlling apparatus 300. Namely, the battery charging/discharging management unit 360 performs certain conversion (including a DC/AC conversion) on power charged in the battery 310, and supplies the converted AC power to the external charging device. In this case, the battery charging/discharging management unit 360 may include a second switch unit (not shown) between an output stage of the converted AC power and the external charging device. In case of discharging the battery, the second switch unit may be turned on based on the second control signal to allow the outputted AC power to be supplied to the external charging device. Also, the second switch unit may be turned off in other cases than discharging the battery, to cut off the connection between the battery 310 and the external charging device.

Also, the controller 350 calculates selling information including at least one of a selling duration (or a discharge duration), a selling amount (or discharge amount), and a selling fee (or a discharge fee) according to selling of the battery 310 which is actually on selling. Here, the calculated selling fee is a rate corresponding to a discharge amount for discharging of the battery 310 based on power fee information (e.g., 0.11 dollars per kw) when of selling power previously stored in the storage unit 340.

When power charged in the battery 310 is sold to the external charging device or the like, the controller 350 may control selling of the power charged in the battery 310 based on pre-set selling configuration information. Namely, when the vehicle including the battery 310 uses power charged in the battery 310 for a certain distance or during a certain time period or when power charged in the battery 310 is sold to the external charging device in order to prevent the occurrence of a case in which the vehicle cannot use power charged in the battery 310 because the battery 310 is charged beyond a predetermined threshold, the controller 350 provides control to satisfy the state of charge (SOC) of the battery 310 to satisfy pre-set selling configuration information. In this case, the selling configuration information may include a minimum charge amount (e.g., 30 percent of the rated capacity of the battery), a minimum operation distance (or a minimum operation distance corresponding to a certain first charge amount), a minimum charge fee (or a charge fee corresponding to a certain second charge amount), or a state of health (SOH) of the battery.

For example, when the battery charging/discharging management unit 360 sells power charged in the battery 310 to the external charging device based on the generated second control signal, the controller 350 checks the state of charge of the battery 310 in real time based on the pre-set selling information including the information that the minimum charge amount of the battery 310 is set to be 10 KW. When the checked state of charge of the battery 310 is less than the pre-set minimum charge amount, the controller 350 provides control to stop the selling of power charged in the battery 310.

As another example, when power charged in the battery 310 is sold to the external charging device, the controller 350 checks the state of charge (SOC) of the battery 310 in real time based on the pre-set selling information including information that the minimum operation distance is set to be 15 km, calculates a running available distance corresponding to the checked state of charge of the battery 310, and compares the calculated running available distance and the pre-set minimum operation distance. When the calculated running available distance is less than the pre-set minimum operation distance, the controller 350 provides control to stop selling power charged in the battery 310.

As another example, when power charged in the battery 310 is sold to the external charging device, and the price of power sold from the battery 310 is higher than the price of power when the battery 310 was charged, the controller 350 corrects the price difference according to the state of health (SOH) of the battery. In some implementations, the controller 350 corrects the price difference only when the price difference between the time when the power is sold and the time when the battery was charged is greater than a price difference according to the SOH.

The controller 350 may display a user interface screen image or a graphic user interface screen image for configuring the selling configuration information on the display unit 370. The controller can further configure the selling configuration information according to a user input (e.g., an input according to a touch screen method). In this case, the selling configuration information may be transmitted to a navigation device or a certain telematics terminal provided in the vehicle through the communication unit 330, the transmitted selling configuration information may be displayed on a display unit of the navigation device or the telematics terminal, the selling configuration information may be configured according to a user input, and the configured selling configuration information may be then transmitted to the battery controlling apparatus 300.

The controller 350 may store information regarding the number of times of the battery 310 has been discharged. The controller 350 may output information including a selling state of the battery 310 checked in real time, a communication connection state, and the like, through the display unit 370 and/or the voice output unit 380 (S420).

The controller 350 may calculate operation information including information regarding a movement distance (or an operation distance) by which the vehicle has moved (or run or traveled) by using the battery 310. In some implementations, the movement distance information can include a movement distance in association with weather or a road state.

In this case, the controller 350 may receive operation information calculated by a driving management system provided in the vehicle through the communication unit 330. Here, the battery controlling apparatus 300 and the vehicle may communicate by using a CAN, i.e., a vehicle network system, or Bluetooth™, Radio Frequency IDentification (RFID), Infrared Data Association (IrDA), Ultra-WideBand (UWB), ZigBee™, and the like, i.e., a short-range communication network.

The controller 350 may output the operation information checked in real time through the display unit 370 and/or the voice output unit 380 (S430).

The detection unit 320 may detect the state of charge (SOC) of the battery 310. The detection unit 320 may additionally detect the voltage and/or current of each cell of the battery 310, and calculate the state of charge (SOC) based on the detected voltage value and/or current value. The detection unit 320 may detect temperature information (including the temperature within the battery 310 and the temperature of the surrounding environment) of the battery 310. The detection unit 320 may detect internal resistance of each cell of the battery 310.

The detection unit 320 may calculate a state of health (SOH) of the battery 310 based on the detected voltage value, current value, internal resistance value, temperature information, and the number of times the battery 310 is charged or discharged.

In some instances, the state of charge (SOC), the state of health (SOH), the voltage value, the current value, the temperature information, and the like, are included in the status information of the battery 310, and the status information of the battery 310 may further include unique information of the battery 310. In this case, the unique information of the battery 310 may include at least one of a rated capacity, a rated voltage, and a rated current of a reference battery.

The controller 350 may output the status information of the battery 310 checked in real time through the display unit 370 and/or the voice output unit 380 (S440).

Thereafter, the controller 350 may calculate gas mileage information regarding the vehicle including the battery 310 based on the calculated charge information running information, and the status information of the battery 310 or the like. In this case, the controller 350 may calculate gas mileage information according to a range previously set by the user such as an average gas mileage (e.g., a gas mileage according to a movement distance per 1 kw), a pre-set gas mileage of by section, gas mileage by date, gas mileage for various weather types (e.g., a gas mileage according to weather such as rainy day, snowy day, sunny day, cloudy day, foggy day, and the like), gas mileage of various road states (e.g., a gas mileage according to a road state such as driving downtown, driving in an expressway, driving in a mountainous land, paved/non-paved road driving, and the like). The controller 350 may output the gas mileage information checked in real time through the display unit 370 and/or the voice output unit 380 (S450).

Thereafter, the controller 350 checks the operational state (including a charge operational state, a discharge (selling) operational state, and the like) of the battery 310 or status information regarding the vehicle including information regarding an operational state or the like of each of one or more elements (including, for example, a driving management system (or the M/G unit), a hydraulic control system, a brake control system (or the BCU) of the vehicle, a hybrid electric vehicle electronic control unit (HEV-ECU), or the like) included in the vehicle including the battery controlling apparatus 300. In this case, the controller 350 may receive status information regarding the vehicle transmitted from the vehicle through the communication unit 330 connected with the vehicle (S460).

Thereafter, the controller 350 may generate (or calculate) battery management information including at least one of the charge information, the selling information, the selling configuration information, the running information, the battery status information, the gas mileage information, the status information regarding the vehicle, and the like, store the generated battery management information in the storage unit 340, and output the generated battery management information through the display unit 370 and/or the voice output unit 380 (S470).

In this manner, the battery management information including information related to the battery controlling apparatus 300 can be stored in a database or other storage configuration, and the stored battery management information may be provided to the user.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A process of using a wireless device to facilitate charging of an electric vehicle battery leveraging smart power grid technology, the process comprising:
establishing a wireless communication session between a wireless device and an electric vehicle battery charge station;
identifying one or more characteristics of the electric vehicle battery charge station;
obtaining control information from a user of the wireless device relating to battery charge management for an electric vehicle battery;
storing the control information to a database;
identifying battery status information for the electric vehicle battery;
generating a control signal based on at least two of the obtained control information, the identified battery status information, and the identified characteristics; and
indicating to the user, by leveraging a user interface of the wireless device, power transfer information;
wherein the obtained control information includes information that can be used to identify a target capacity for the electric vehicle battery.

2. The process of claim 1, wherein the control signal is generated based on the obtained control information and the identified battery status information.

3. The process of claim 1, wherein the control signal is generated based on the obtained control information and the identified characteristics.

4. The process of claim 1, wherein the control signal is generated based on the identified battery status information and the identified characteristics.

5. The process of claim 1, wherein the power transfer information relates to a power transfer function performed in association with the generated control signal.

6. The process of claim 1, further comprising providing the generated control signal to a battery charging/discharging management unit.

7. The process of claim 1, wherein the control signal is generated based on the obtained control information and the identified battery status information to the exclusion of the identified characteristics, and the control signal is generated at the wireless device and transmitted to the electric vehicle battery charge station.

8. The process of claim 1, wherein the electric vehicle battery charge station includes a power meter, a charging unit, and a wireless communication interface.

9. The process of claim 1, wherein identifying one or more characteristics of the electric vehicle battery charge station includes determining the identity of an entity associated with the electric vehicle battery charge station.

10. The process of claim 1, wherein identifying one or more characteristics of the electric vehicle battery charge station includes determining charge characteristics of the electric vehicle battery charge station.

11. The process of claim 10, wherein the charge characteristics relate to a cost of power associated with the electric vehicle battery charge station.

12. The process of claim 10, wherein determining charge characteristics includes:
determining one or more of a peak cost, an average cost, or a minimum cost of power associated with the electric vehicle battery charge station for a given time period; and
using at least one of the determined peak cost, average cost, and minimum cost to generate the control signal.

13. The process of claim 12, further including:
determining a peak cost of power associated with the electric vehicle battery charge station for a given time period;
identifying a threshold based on the peak cost;
comparing a present power cost to the threshold;
determining that the present power cost satisfies the threshold; and
generating a control signal to invoke a power transfer between the electric vehicle batter and the electric vehicle battery charge station, responsive to the determining.

14. The process of claim 1, wherein obtaining control information includes:
soliciting control information from a user of the wireless device, the control information relating to battery charge management for the electric vehicle battery; and
receiving the control information provided by the user.

15. The process of claim 1, wherein establishing the communication session between the wireless device and the electric vehicle battery charge station includes establishing a wireless communication session between an electric vehicle that includes the electric vehicle battery and the electric vehicle battery charge station.

16. The process of claim 15, wherein establishing the communication session between the wireless device and the electric vehicle battery charge station further includes establishing a wireless communication session between the wireless device and the electric vehicle.

17. The process of claim 1, wherein the obtained control information includes an indication of a charge start time and a charge duration and the control signal indicates that a battery charging function is to start at the indicated charge start time and last for no longer than the indicated charge duration.

18. The process of claim 1, wherein the obtained control information includes an indication of a discharge start time and a discharge duration and the control signal indicates that a battery discharging function is to start at the indicated charge start time and last for no longer than the indicated discharge duration.

19. The process of claim 1, wherein the obtained control information includes an indication of a monetary value and wherein the control signal indicates that the battery is to be charged or discharged until an amount of power equal to the indicated monetary value has been charged to or discharged from the battery.

20. The process of claim 1, wherein the obtained control information includes an indication of one or more of a target charge capacity, a target discharge capacity, a target charge percentage, or a target discharge percentage and wherein the control signal indicates that a power transfer function is to occur with respect to the battery until the indicated target charge capacity, target discharge capacity, target charge percentage, or target discharge percentage is satisfied.

21. A system for charging of an electric vehicle battery leveraging smart power grid technology, the system comprising:
a wireless communication unit configured to establish a wireless communication session with a wireless device and receive control information relating to battery charge management for an electric vehicle battery;
a memory configured to store one or more characteristics of an electric vehicle battery charge station;
a detection unit configured to identify battery status information for the electric vehicle battery; and
a controller configured to generate a control signal based on at least two of the control information, the battery status information, and the characteristics;
wherein the control information includes information that can be used to identify a target capacity for the electric vehicle battery.

22. The system of claim 21, wherein the wireless device is an electric vehicle that includes the electric vehicle battery.

23. The system of claim 21, wherein the wireless communication unit is further configured to establish a wireless communication session with an electric vehicle that includes the electric vehicle battery, and the wireless communication unit receives the control information from the wireless device.

24. The system of claim 21, wherein the wireless device includes a user interface for indicating, to a user, power transfer information relating to a power transfer function performed in association with the control signal.

25. A system for charging of an electric vehicle battery leveraging smart power grid technology, the system comprising:
a wireless communication unit configured to establish a wireless communication session with a wireless device;
a memory configured to store one or more characteristics of an electric vehicle battery charge station;
means for obtaining control information from a user of the wireless device relating to battery charge management for an electric vehicle battery;
a detection unit configured to identify battery status information for the electric vehicle battery; and
a controller configured to generate a control signal based on at least two of the control information, the battery status information, and the characteristics;
wherein the control information includes information that can be used to identify a target capacity for the electric vehicle battery.
